(19) United States
(12) Patent Application Publication
(10) Pub. No.: US 2024/0106365 A1
(43) Pub. Date: Mar. 28, 2024

(54) MOTOR CONTROLLER AND CONTROL METHOD THEREOF

(71) Applicant: Acer Incorporated, New Taipei City (TW)

(72) Inventor: Jiunn-Jou LIN, New Taipei City (TW)

(73) Assignee: Acer Incorporated, New Taipei City (TW)

(21) Appl. No.: 18/084,035

(22) Filed: Dec. 19, 2022

(30) Foreign Application Priority Data
Sep. 27, 2022 (TW) 111136532

(51) Int. Cl. H02P 27/06; B62M 6/40; B62M 6/90

(52) U.S. Cl. CPC H02P 27/06; B62M 6/40; B62M 6/90; H02P 2201/09

(57) ABSTRACT

The application provides a motor control method for driving a motor. The motor control method includes: at a normal status, when the motor outputs power, determining whether an output current of the motor reaches a maximum current limit; when the output current of the motor reaches the maximum current limit, controlling the motor to enter a boosting status to raise a maximum instantaneous output power of the motor; and when the motor has reached a maximum time limit within a boosting period at the boosting status, or when the output current of the motor drops from the maximum current limit, controlling the motor to return to the normal status from the boosting status.

This application claims the benefit of Taiwan application Serial No. 111136532, filed Sep. 27, 2022, the subject matter of which is incorporated herein by reference.

### BACKGROUND OF THE INVENTION

### Field of the Invention

The invention relates in general to a motor controller and a control method thereof.

### Description of the Related Art

Electricity-assisted bike is hot and popular in the global market. Electricity-assisted bike is fascinating in that, the rider, with the same effort, can climb steeper slope and reach farther distance than usual and can fully enjoy beautiful scenery along the way.

The electricity-assisted bike currently available in the market outputs different levels of auxiliary boost according to the gear selected by the user, the auxiliary boost outputted by the motor depends on the volume of voltage and current flowing through the motor control system. However, the motor controller and the motor are normally subjected to the restriction of maximum current, which would therefore limit the motor output power. In terms of design, the motor is more flexible with the voltage and is compatible with a wider range of voltage. If a higher voltage can be inputted under the same current, the motor will generate larger power and torque, which will provide a larger auxiliary boost to the electricity-assisted bike.

Therefore, it has become a prominent task for the industry to provide even larger instantaneous auxiliary boost and instantaneous power in compliance with safety regulations of the motor.

The present application provides a motor controller and a control method thereof capable of providing larger instantaneous maximum auxiliary boost in compliance with safety regulations to meet the rider's different needs under different environmental conditions and temporarily provide the rider with an instantaneous auxiliary boost sufficient for starting the bike.

### SUMMARY OF THE INVENTION

According to one embodiment of the present invention, a motor controller used to control and drive a motor is provided. The motor controller includes a battery for providing a battery output voltage; a boosting circuit coupled to the battery; a voltage conversion circuit coupled to the battery to convert the battery output voltage provided by the battery to generate a converted voltage; a micro-controller coupled to the voltage conversion circuit and the boosting circuit to receive the converted voltage from the voltage conversion circuit, wherein the micro-controller is for activating the boosting circuit; and a three-phase inverter coupled to the boosting circuit, the micro-controller and the motor, wherein the micro-controller outputs a control signal to the three-phase inverter to control the three-phase inverter to drive the motor. Wherein, at a normal status, the battery output voltage provided by the battery is converted by the voltage conversion circuit and is provided to the micro-controller and the three-phase inverter, wherein the three-phase inverter drives and enables the motor to provide a first instantaneous output power; and at a boosting status, the micro-controller activates the boosting circuit, the boosting circuit boosts the battery output voltage provided by the battery and provides the boosted battery output voltage to the three-phase inverter, the three-phase inverter drives and enables the motor to provide a second instantaneous output power, wherein the second instantaneous output power is higher than the first instantaneous output power.

According to another embodiment of the present invention, a motor control method for driving a motor is provided. The motor control method includes: at a normal status, determining whether an output current of the motor reaches a maximum current limit when the motor outputs power; controlling the motor to enter a boosting status to raise a maximum instantaneous output power of the motor when the output current of the motor reaches the maximum current limit; and controlling the motor to return to the normal status from the boosting status when the motor has reached a maximum time limit within a boosting period at the boosting status or when the output current of the motor drops from the maximum current limit.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a functional block diagram of a motor controller according to an embodiment of the present application.

FIG. 2A and FIG. 2B are parameter curve diagrams of a motor controller under different input voltages according to an embodiment of the present application.

FIG. 3 is a flowchart of a motor control method according to an embodiment of the present application.

FIG. 4 is a waveform diagram of a motor output power according to an embodiment of the present application.

### DETAILED DESCRIPTION OF THE INVENTION

Technical terms are used in the specification with reference to the prior art used in the technology field. For any terms described or defined in the specification, the descriptions and definitions in the specification shall prevail. Each embodiment of the present disclosure has one or more technical features. Given that each embodiment is implementable, a person ordinarily skilled in the art can selectively implement or combine some or all of the technical features of any embodiment of the present disclosure.

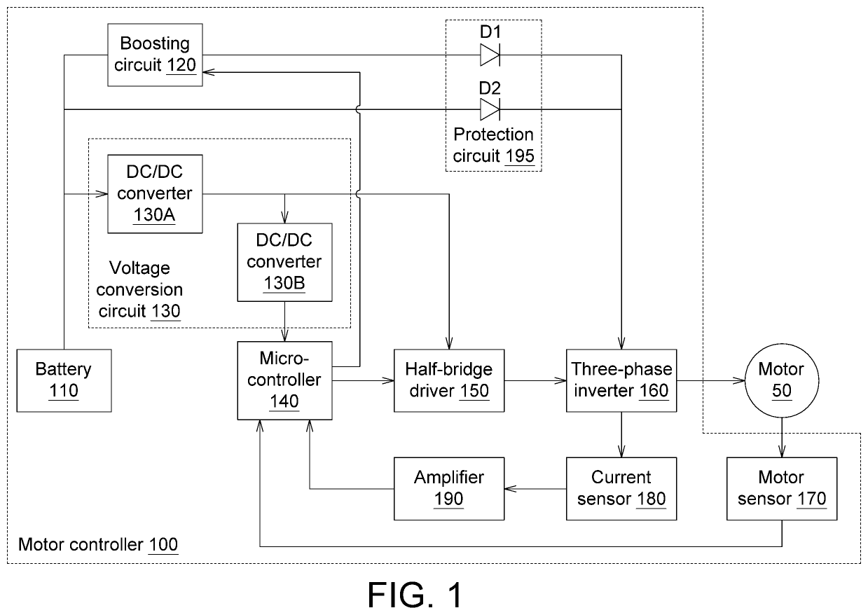

Referring to FIG. 1, a functional block diagram of a motor controller according to an embodiment of the present application is shown. The motor controller 100 according to an embodiment of the present application may be used in an electricity-assisted bike but is not limited thereto. The motor controller 100 drives a motor 50.

The motor controller 100 according to an embodiment of the present application includes: a battery 110, a boosting circuit 120, a voltage conversion circuit 130, a micro-controller 140, a half-bridge driver 150, a three-phase inverter 160, a motor sensor 170, a current sensor 180, an amplifier 190 and a protection circuit 195.

The battery 110 is used to provide a voltage and a current.

The boosting circuit 120 is coupled to the battery 110 to boost the battery output voltage provided by the battery 110 and to provide the boosted battery output voltage the three-phase inverter 160.

The voltage conversion circuit 130 is coupled to the battery 110 to convert the battery output voltage provided by the battery 110 and to provide the converted battery output voltage to the micro-controller 140 and the half-bridge driver 150. The voltage conversion circuit 130 includes a first DC/DC converter 130A and a second DC/DC converter 130B. The first DC/DC converter 130A is coupled to the battery 110 to convert the battery output voltage provided by the battery 110 and to provide the converted battery output voltage to the second DC/DC converter 130B and the half-bridge driver 150. The second DC/DC converter 130B is coupled to the first DC/DC converter 130A to convert an output voltage of the first DC/DC converter 130A and to provide the converted output voltage to the micro-controller 140. Here below, the output voltage provided to the micro-controller 140 by the voltage conversion circuit 130 is referred as the first converted voltage, and the output voltage provided to the half-bridge driver 150 by the voltage conversion circuit 130 is referred as the second converted voltage.

The micro-controller 140 is coupled to the voltage conversion circuit 130 and the boosting circuit 120 to receive an output voltage from the second DC/DC converter 130B. The micro-controller 140 outputs a control signal to control a plurality of MOS transistors inside the three-phase inverter 160. Besides, the micro-controller 140 is in charge of activating the boosting circuit 120. The micro-controller 140 is implemented by hardware or software or firmware.

The half-bridge driver 150 is coupled to the micro-controller 140 to boost the voltage of the control signal outputted by the micro-controller 140 and to output the boosted control signal to the three-phase inverter 160.

The three-phase inverter 160 is coupled to the half-bridge driver 150. The three-phase inverter 160 receives the control signal from the micro-controller 140 via the half-bridge driver 150. The three-phase inverter 160 includes a plurality of MOS transistors, which are controlled to drive the motor 50 by the control signal outputted by the micro-controller 140.

The motor sensor 170 is coupled to the micro-controller 140 to sense a rotation speed and a position of the motor 50 and to transmit the sensing result to the micro-controller 140. The micro-controller 140 adjusts the control signal according to the motor sensing result of the motor sensor 170.

The current sensor 180 is coupled to the three-phase inverter 160 to sense an output current of the three-phase inverter 160 and to transmit the current sensing result to the micro-controller 140 through the amplifier 190. The micro-controller 140 adjusts the control signal according to the current sensing result of the current sensor 180. The motor sensor 170 and the current sensor 180 are used to sense whether the action of the motor 50 complies with the expectations.

The amplifier 190 is coupled to the current sensor 180 to amplify a current sensing result of the current sensor 180 and to transmit the amplified current sensing result to the micro-controller 140.

The protection circuit 195 is coupled to boosting circuit 120 and the battery 110 to avoid the battery 110 being directly recharged by the boosted voltage outputted by the boosting circuit 120. The protection circuit 195 includes a first diode D1 and a second diode D2. The first diode D1 is coupled between the boosting circuit 120 and the three-phase inverter 160. The second diode D2 is coupled between the battery 110 and the three-phase inverter 160.

Operations of the motor controller 100 according to an embodiment of the present application are disclosed below.

Here below, the operation status of the motor controller 100 and the motor 50 is divided into a normal status and a boosting status. The micro-controller 140 is switched between the normal status and the boosting status according to the motor output.

At the normal status, the voltage conversion circuit 130 converts the battery output voltage provided by the battery 110 and provides the converted battery output voltage to the micro-controller 140, the half-bridge driver 150 and the three-phase inverter 160. The micro-controller 140 is in charge of controlling and switching the MOS transistors inside the three-phase inverter 160, so that the output current of the MOS transistors drives the motor 50 to rotate according to the control signal of the micro-controller 140. The half-bridge driver 150 is in charge of boosting the voltage of the control signal of the micro-controller 140. The motor sensor 170 and the current sensor 180 transmit the sensing result to the micro-controller 140, so that the micro-controller 140 adjusts the control signal. The amplifier 190 amplifies the current sensing result of the current sensor 180.

At the boosting status, in addition to the operations at the normal status, the micro-controller 140 activates the boosting circuit 120 and provides the voltage boosted by the boosting circuit 120 to the three-phase inverter 160, so that the three-phase inverter 160 provides an even higher driving voltage to the motor 50, which provides an even higher instantaneous output power. That is, the motor 50 provides the first instantaneous output power and the second instantaneous output power at the normal status and the boosting status respectively, wherein the second instantaneous output power is higher than the first instantaneous output power.

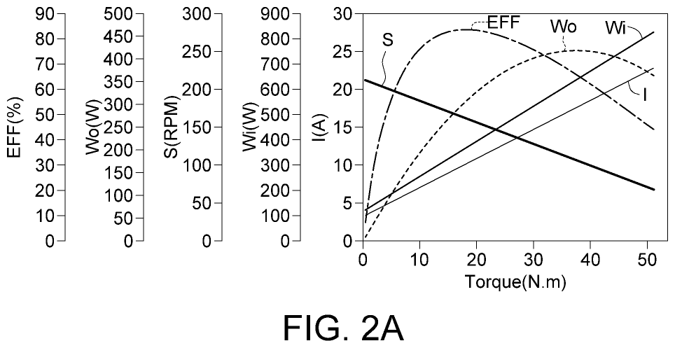

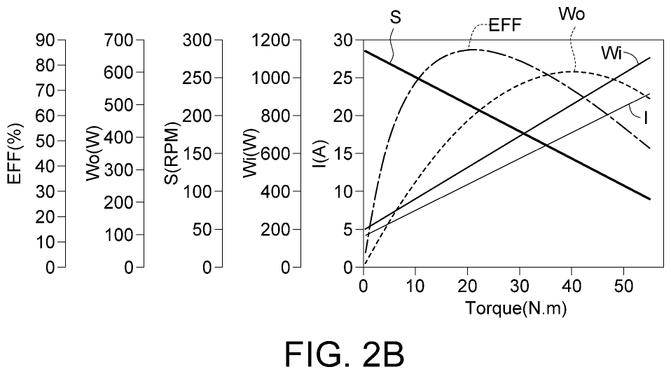

FIG. 2A and FIG. 2B are parameter curve diagrams of a motor controller under different input voltages according to an embodiment of the present application. For the convenience of elaboration, input voltages of FIG. 2A and FIG. 2B are exemplified by 36V and 48V, respectively, but the present application is not limited thereto.

In FIG. 2A and FIG. 2B, EFF represents a motor efficiency (%); Wo represents a motor output power (W); Wi represents a motor input power (W); S represents the motor rotation speed (RPM); I represents an output current (A) of the motor.

Since the torque and rotation speed generated by the same motor under different input voltages are not the same, the output power responses are also different. The motor output power and the motor input power are obtained according to the formulae below, but the present application is not limited thereto.

Input power (W)=input voltage (V)×input current (A).

Output power (W)=torque (N·m)×rotation speed (RPM)×2×π÷60.

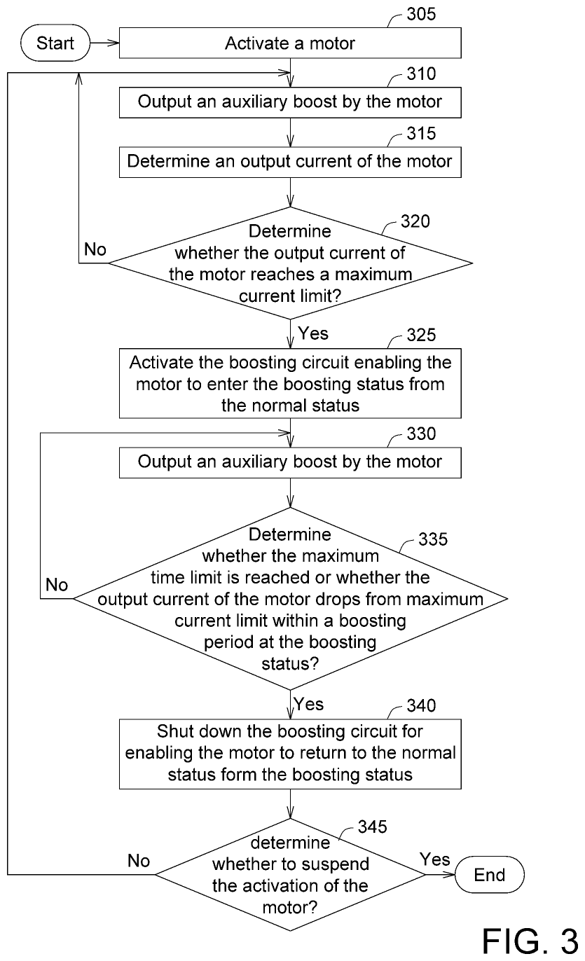

FIG. 3 is a flowchart of a motor control method according to an embodiment of the present application. The motor of FIG. 3 is controlled by the micro-controller 140. As indicated in FIG. 3, in step 305, the motor 50 is activated. In step 310, a power is outputted by the motor 50, that is, the motor 50 outputs a power to an electricity-assisted bike.

In step 315, an output current of the motor 50 is determined by the micro-controller 140. In step 320, whether the output current of the motor 50 reaches a maximum current limit is determined by the micro-controller 140. If the determination in step 320 is negative, the process returns to step 310; if the determination in step 320 is positive, the process proceeds to step 325. If the output current of the motor 50 reaches a maximum current limit, this indicates that at the normal status the motor has reached the maximum instantaneous output power, and the motor controller 100 will enter a boosting status to raise the maximum instantaneous output power of the motor 50.

In step 325, the boosting circuit 120 is activated by the micro-controller 140 for enabling the motor 50 to enter the boosting status from the normal status. In step 330, an auxiliary boost is outputted by the motor 50.

In step 335, whether the maximum time limit is reached or whether the output current of the motor 50 drops from maximum current limit within a boosting period at the boosting status is determined by the micro-controller 140. In an embodiment of the present application, to protect the motor 50, a maximum time limit at the boosting status is set; if the maximum time limit at the boosting status is reached, the motor 50 is not allowed to stay at the boosting status, otherwise the motor 50 may be burnt down. In an embodiment of the present application, at the boosting status, if the micro-controller 140 determines that the output current of the motor 50 has dropped from the maximum current limit, this indicates that the rider no longer needs the motor 50 to be at the boosting status, and the motor 50 returns to the normal status from the boosting status.

If the determination in step 335 is negative, the process returns to step 330 (the boosting status continues). If the determination in step 335 is positive, the process proceeds to step 340.

In step 340, the boosting circuit 120 is shut down by the micro-controller 140 for enabling the motor 50 to return to the normal status form the boosting status.

In step 345, whether to suspend the activation of the motor 50 is determined by the micro-controller 140. If the determination in step 345 is negative, the process returns to step 310 (the normal status continues). If the determination in step 345 is positive, the process terminates.

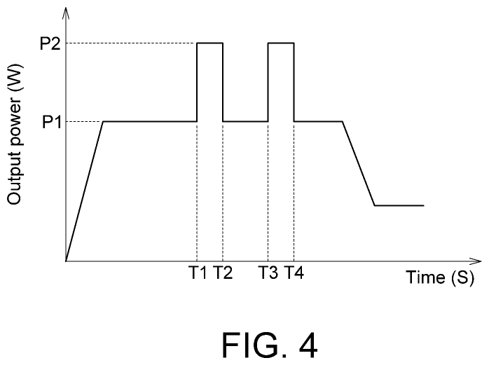

FIG. 4 is a waveform diagram of a motor output power according to an embodiment of the present application. As indicated in FIG. 4, at time points T1 and T3, the motor controller 100 enters the boosting status to raise the maximum instantaneous output power of the motor 50. At time points T2 and T4, the micro-controller 140 determines whether the maximum time limit Tₗᵢₘᵢₜ is reached within the boosting period at the boosting status; if so, the motor 50 returns to the normal status form the boosting status. P1 and P2 represent the output power of the motor 50 at the normal status and the boosting status, respectively.

From FIG. 4, in an embodiment of the present application, when the output power of the motor 50 continuously reaches the maximum, as long as the motor 50 is not damaged, the motor 50 remains at the boosting status where the rider's burden is alleviated and auxiliary boost is provided to overcome slope climbing or the instantaneous work of maximum resistance.

In an embodiment of the present application, the activation of the boosting circuit 120 of the motor controller 100 is controlled by the micro-controller 140; the boosted voltage outputted by the boosting circuit 120 is the maximum voltage allowed by the motor 50 (exemplified by but not limited to 48V; at the normal status, the working voltage of the motor 50 is between 30V˜42V); the output current must also be the maximum current of the motor controller 100 (for instance, when the output power is 500 W, the maximum current can be set to 18 A, when the output power is 250 W, the maximum current can be set to 15 A); one of the boosted voltage of the boosting circuit 120 and the output voltage of the voltage conversion circuit 130 is selected and inputted to the three-phase inverter 160. When a larger instantaneous auxiliary boost needs to be outputted, the micro-controller 140 selects the boosting circuit 120 to meet the requirement of a larger torque output.

In an embodiment of the present application, the motor controller 100 at least has the following advantages: 1) the instantaneous torque output is increased; 2) the slope climbing ability of the electricity-assisted bike is improved; 3) a larger torque output is provided without changing motor specifications; 4) additional rider operation mode is provided; 5) application of the motor is effectively increased.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A motor controller for controlling and driving a motor, the motor controller comprising:
a battery for providing a battery output voltage;
a boosting circuit coupled to the battery;
a voltage conversion circuit coupled to the battery to convert the battery output voltage provided by the battery to generate a converted voltage;
a micro-controller coupled to the voltage conversion circuit and the boosting circuit to receive the converted voltage from the voltage conversion circuit, wherein the micro-controller is for activating the boosting circuit; and
a three-phase inverter coupled to the boosting circuit, the micro-controller and the motor, wherein the micro-controller outputs a control signal to the three-phase inverter to control the three-phase inverter to drive the motor;
wherein,
at a normal status, the battery output voltage provided by the battery is converted by the voltage conversion circuit and is provided to the micro-controller and the three-phase inverter, wherein the three-phase inverter drives and enables the motor to provide a first instantaneous output power; and
at a boosting status, the micro-controller activates the boosting circuit, the boosting circuit boosts the battery output voltage provided by the battery and provides the boosted battery output voltage to the three-phase inverter, the three-phase inverter drives and enables the motor to provide a second instantaneous output power, wherein the second instantaneous output power is higher than the first instantaneous output power.

2. The motor controller according to claim 1, wherein, the micro-controller:
at the normal status, determines whether an output current of the motor reaches a maximum current limit when the motor outputs power;
controls the motor to enter the boosting status to turn on the boosting circuit when the output current of the motor reaches the maximum current limit;
determines whether the motor has reached a maximum time limit within a boosting period at the boosting status or whether the output current of the motor has dropped from the maximum current limit; and
shuts down the boosting circuit and controls the motor to return to the normal status from the boosting status when the output current of the motor has reached the maximum time limit or has dropped from the maximum current limit within the boosting period at the boosting status.

3. The motor controller according to claim 2, further comprising:
a protection circuit coupled to the boosting circuit and the battery to avoid the battery being recharged by a boosted voltage outputted by the boosting circuit.

4. The motor controller according to claim 3, wherein, the protection circuit comprises a first diode and a second diode; the first diode is coupled between the boosting circuit and the three-phase inverter; and the second diode is coupled between the battery and the three-phase inverter.

5. The motor controller according to claim 1, further comprising:
a half-bridge driver coupled between the micro-controller and the three-phase inverter to boost the control signal outputted by the micro-controller and output the boosted control signal to the three-phase inverter;
a motor sensor coupled to the micro-controller to sense a rotation speed and a position of the motor and transmit a motor sensing result to the micro-controller, the micro-controller adjusts the control signal according to the motor sensing result of the motor sensor; and
a current sensor coupled to the three-phase inverter and the micro-controller to sense an output current of the three-phase inverter and transmit a current sensing result to the micro-controller, the micro-controller adjusts the control signal according to the current sensing result of the current sensor.

6. A motor control method for driving a motor, the motor control method comprising:
at a normal status, determining whether an output current of the motor reaches a maximum current limit when the motor outputs power;
controlling the motor to enter a boosting status to raise a maximum instantaneous output power of the motor when the output current of the motor reaches the maximum current limit; and
controlling the motor to return to the normal status from the boosting status when the motor has reached a maximum time limit within a boosting period at the boosting status or when the output current of the motor drops from the maximum current limit.

7. The motor control method according to claim 6, further comprising:
determining whether to stop the activation of the motor;
maintaining the motor at the normal status when the activation of the motor does not need to be suspended; and
terminating the motor control method when the activation of the motor needs to be suspended.
